(19) United States
(12) Patent Application Publication
(10) Pub. No.: US 2018/0142828 A1
(43) Pub. Date: May 24, 2018

(54) LINING TUBE FOR THE RENOVATION OF FLUID-CONDUCTING SYSTEMS

(71) Applicant: SML Verwaltungs GmbH, Rohrbach (DE)

(72) Inventors: Stefan REICHEL, Bad Duerkheim (DE); Christian NOLL, Limburgerhof (DE)

(21) Appl. No.: 15/535,653

(22) PCT Filed: Dec. 15, 2015
(86) PCT No.: PCT/EP2015/079674

§ 371 Date: Oct. 24, 2017

(30) Foreign Application Priority Data
Dec. 15, 2014 (DE) 10 2014 118 689.3

(51) Int. Cl. F16L 55/165; B32B 1/08; B32B 5/02; B32B 17/06

(52) U.S. Cl. CPC F16L 55/1656; B32B 1/08; B32B 5/02; B32B 2597/00; F16L 55/1654; B32B 2262/101; B32B 17/064

(57) ABSTRACT

Lining hose for the renovation of fluid carrying pipe systems comprising at least one resin impregnated fiber hose and, optionally, a reinforced or unreinforced inner tubular foil hose on the side of the resin impregnated fiber hose oriented towards the flowing medium, wherein nanoparticles are added to the resin used for impregnation or to the inner tubular foil hose or to both.

The present invention relates to a liner tube (hereinafter referred to as lining hose) for the renovation of fluid carrying systems comprising at least one resin impregnated fiber hose.

Lining hoses for the renovation of fluid-carrying systems are known per se and have been described in the literature.

In practice so called liner tubes (lining hoses) based on thermoplastic polymers comprising a fiber reinforcement have proved to be suitable. These liner tubes are flexible lining hoses which are introduced into the pipe system to be renovated, are thereafter expanded to fit snugly or adapt to the inner wall of the conduit system to be renovated and subsequently are brought into their final shape by curing (hardening) the resin contained in the fiber hose.

The manufacture of such lining hoses is described e.g. in WO 95/04646. In accordance with the process described therein, a foil tape is helically wound onto a mandrel consisting of multiple parallel winding fingers which are adjustable in their distance to the mandrel axis, thereby forming an inner tubular foil serving as protective foil. Onto the inner tubular foil thus obtained, at least one fiber ribbon is wound, onto which a second foil tape is wound which forms an outer tubular foil (foil hose).

Curable polymers with nanoparticulate fillers have been described in the literature for various applications.

In EP A 1502727 composite molded elements are described which are obtained by injection of a low viscosity polymer into a fiber base and subsequent curing by heating. Prior to injection, nanoparticles are added to the low viscosity polymer. The products obtained are so-called pre-pregs, which are no longer flexible after curing. The use in lining hoses for renovating fluid-carrying systems is neither disclosed nor suggested.

EP A 1 634 921 and EP-A 1 786 866 relate to polymeric compositions which, besides an unsaturated polyester and a further copolymer with functional groups reactive towards the polyester, contain nanoparticles as fillers. Composite materials, coatings, casting compounds, glues and dental materials with improved mechanical properties, in particular improved impact strength, can be obtained from such compositions.

In US 2010/0143701 a process is described, wherein carbon nanotubes dispersed in a solvent are applied onto a fibrous surface, thereafter the solvent is evaporated and finally the coated surface thus obtained is covered with a polymer to obtain a fiber reinforced composite material with embedded carbon nanotubes.

WO A 2005/028174 relates to the manufacture of polymer composites based on epoxy resins comprising functionalized carbon nanotubes.

It was an object of the present invention to provide lining hoses for the renovation of fluid-carrying systems having advantageous mechanical properties and an abrasion resistant surface.

This object is achieved in accordance with the present invention with the lining hoses in accordance with claim 1. Preferred embodiments of the lining hoses in accordance with the invention are described in the dependent claims and in the detailed specification hereinafter.

A further embodiment of the present invention relates to a process for the manufacture of the lining hoses in accordance with the present invention and the use of the lining hoses in accordance with the present invention for the renovation of water and wastewater conduit systems

The term fluid-carrying system, when used herein, is intended to cover any and all systems in which fluids, i.e. gases or liquids, can be transported (conveyed). There are no particular limitations with regard to construction type, diameter or materials of the systems to be renovated.

The material selection is determined by the fluid media to be transported; their properties ultimately determine the lifetime of such systems and the need for a renovation, which may be carried out with the lining hoses in accordance with the present invention.

Accordingly, the subject of the present invention is a lining hose for the renovation of fluid-carrying systems, comprising at least one resin impregnated fiber hose, and optionally comprising a reinforced or unreinforced inner tubular foil hose on the surface of the resin impregnated fiber hose oriented towards the flowing medium, wherein 0.1 to 40 wt % of nanoparticles, based on the weight of the resin respectively based on the weight of the inner tubular hose, are added to the resin used for impregnation or to the inner tubular foil hose or to both. This means that either the resin used for impregnation may contain 0.1 to 40 wt %, based on the total weight of the resin, of nanoparticles or that an inner tubular foil can contain 0.1 to 40 wt %, based on the weight of the tubular foil, of nanoparticles or that nanoparticles may be present in both mentioned components of the lining hose in the amounts given. It is preferred that nanoparticles are contained in the (tubular) fiber hose which, after installation, comes into direct contact with the flowing (streaming) medium. This may be the inner tubular foil hose if same remains in the lining hose after installation or it may be the resin-impregnated tubular fiber hose if the inner tubular foil is removed after installation.

The term “nanoparticles”, as used herein in the context of the present invention, is intended to cover any and all particulate or fiber shaped particles the greatest dimensional extension of which in one or more spatial directions, or in case of spherical or bullet shaped particles, the medium diameter of which, is less than 300 nm, preferably less than 150 nm and particularly preferable less than 100 nm.

The term medium diameter, as used herein in context with the present invention, refers to the medium diameter D₅₀ based on the intensity weighed particle size distribution as obtained in accordance with the so-called Contin-Data-Inversion algorithm. D₅₀ divides the intensity weighed particle size distribution into two fractions of identical weight, of which the first fraction contains particles with a diameter below D₅₀ and the second fraction contains particles with diameters exceeding D₅₀.

D₅₀ is usually determined through dynamical light scattering in accordance with ISO 22412:2008. The measurement is carried out at a temperature of 25° C. Refractive index and viscosity coefficient of the dispersion medium should be determined as precisely as possible or should be known from literature. After temperature calibration the position of the measurement cell is adjusted to obtain an optimum scattering signal. Details of the measurement can be taken from the ISO standard.

Spherical or bullet shaped particles have a more or less pronounced isometric structure, i.e. their dimensions in all three spatial directions are comparable in size.

The ratio of the dimensions of a particle in two different spatial directions is characterized through the so-called aspect ratio, which describes the maximum ratio of the dimensions of the particle in two different spatial directions. The aspect ratio of ideally spherical particles is 1, whereas the aspect ratio is significantly higher for fiber- or platy shaped particles and often reaches values of 100 or more. Platy or fiber-shaped nanoparticles are therefore characterized through indication of the extension (size) in the spatial direction in which the particle has its greatest size.

Principally any types of inorganic or organic products which can be manufactured in the respective particle sizes or which may also be available commercially are suitable as nanoparticles. Processes for the manufacture of such particles are known to the skilled person and have been described in the literature.

Spherical or bullet shaped particles are e.g. metal oxides, metal carbonates, metal sulfates or the like. Preferred are oxides of Ba, Al, Si, Zr, Ce and Ti and mixed oxides of these metals. Carbonates and sulfates of alkaline or alkaline earth metals may be preferably mentioned in this regard as sulfates or carbonates.

Platy shaped fillers have been described in great variety in e.g. Plastics Additive Additive Handbook (Hanser, 5th Ed.) in chapter 17.4.2 on pages 926 to 930 to which reference is made herewith for further details.

Needle shaped or acicular particles have also been described in the literature in great variety. Preferred acicular additives in the resins used for curing have an aspect ratio in the range of from 2 to 100, preferably in the range of from 2 to 20.

Wollastonite, xonotlite, sepiolite, attapulgite and palygorskite may be mentioned as preferred acicular particles.

Fiber-shaped fillers have an even higher aspect ratio compared to needle shaped fillers. A preferred group of fiber shaped nanoparticles are carbon-based materials, which are also known as carbon nanotubes.

Further suitable fiber shaped nanoparticles which may be mentioned here are glass fibers or fibers based on Al, Ti, Mg, Al-silicate or Si- or boron carbide fibers. Glass fibers are preferred.

The nanoparticular fillers are added to the resin used for impregnating the resin-impregnated fiber ribbons respectively the inner tubular foil hose in an amount of from 0.1 to 40, preferably of from 2 to 30 and particular of from 3 to 25 wt %, based on the weight of the resin respectively the weight of the inner tubular foil hose.

The addition of the nanoparticles to the resin used for impregnation prior to the impregnation is made according to methods known per se so that no further information needs to be given here.

The particle size indicated above refers to the point in time of incorporation into the resin used for impregnation. Caused by agglomeration in the course of the addition or during the impregnation of the resin impregnated fiber hoses with the nanoparticles containing fiber hoses a different, usually a greater, particle size may result in the final lining hose.

As reactive resins for impregnation of the fiber ribbons, unsaturated polyester resins (UP resins) or vinyl ester resins, which may be dissolved e.g. in styrene and/or an acrylic acid ester are used. Suitable reactive resins of these types are known to the skilled person and commercially available in different grades.

For the manufacture of so called UP-resins multivalent unsaturated dicarboxylic acids are esterified with diols, whereby low molecular weight products are obtained which are polymerized, usually with vinyl compounds (in particular styrene) as co-monomers to high molecular weight three-dimensional networks.

Mixtures of unsaturated and saturated dicarboxylic acids or their anhydrides may also be used as acid component of UP resins. Thus, adipic acid, glutaric acid, phthalic acid, isopthalic acid and terephthalic acid or the reactive derivatives of these acids may be used as acid component. Preferred unsaturated acids are maleic acid or its anhydride, fumaric acid and Diels-Alder adducts of maleic acid anhydride and cyclopentadiene. As preferred diols ethylene glycol, propanediol, dipropanediol, diethylene glycol, 2,2-dimethyl-1,2-propanediol, 1,4-butanediol, 2,2,4-trimethyl-1,3-pentanediol or Bisphenol A are used. The comonomers necessary for crosslinking the UP resins may at the same time serve as solvents for the low molecular weight oligomers; as an example in particular styrene may be mentioned, which is used in many UP resins. Other examples for suitable co-monomers are methyl styrene, vinyl toluene or methyl methacrylate.

Bifunctional monomers such as diallyl phthalate, or divinyl benzene may also be added.

Other components of UP-resins, such as hardeners, polymerization initiators, accelerators, plasticizers or the like are known to the skilled person and have been described in the literature so that no further details need to be given here.

Vinyl ester resins (also named VE-resins), another group of resins suitable for impregnating the fiber ribbons, are obtained by producing in a first step an epoxide oligomer which contains terminal vinyl ester groups such as acrylate or methacrylate groups and thus comprises reactive double bonds. In a second step crosslinking is effected, usually by using styrene as solvent and crosslinking agent. The crosslinking density of VE-resins is usually lower than for UP-resins as less reactive double bonds are present.

In VE-resins, the basic skeleton of the oligomer preferably comprises aromatic glycidyl ethers of phenols or epoxidized novolaks. These are preferably esterified at their terminal positions with (meth)acrylic acid.

The reactive resins used for impregnating the fiber ribbons may be cured thermally (usually with peroxide catalysts) or by radiation, e.g. by UV-light with photoinitiators as e.g. described in EP 23623. Furthermore so-called combination curings with a peroxide initiator used for thermal curing in combination with a photo initiator are possible and have been found advantageous in particular at higher wall thicknesses of the lining hoses. A method for such a combination curing is e.g. disclosed in EP A1 262 708.

After impregnation the resin can be advantageously thickened as described for example in WO A 2006/061129. Thereby the viscosity of the resin increases and the processability and windability of the fiber ribbons used is improved.

As fiber ribbons which are impregnated with the nanoparticles containing reactive resin all the products known to the skilled person in the form of fabrics, knitted fabrics, rovings, mats or non-wovens (fleeces) which may comprise fibers in the form of long endless fibers or short fibers, may be used.

Respective products are known to the skilled person and are commercially available in great variety from multiple suppliers.

The term fabric (textile) generally denotes sheet-like textile products of at least two orthogonally crossed fiber systems, wherein the so-called warp extends in the longitudinal direction and the so-called weft (shute) extends in a direction orthogonal thereto.

The term knitted fabric generally denotes textile products produced through the formation of meshs.

Fiber rovings or rovings are a processing variant of fibers, in which the fibers are not woven, but oriented parallel to each other embedded in a chemical carrier material (the matrix) and which are fixed in place usually through cover foils on the upper and the lower surface and optionally fixed in place with a thread or a glue. Fiber rovings, due to the parallel orientation of the fibers usually show a pronounced anisotropy of stiffness or rigidity in the direction of the orientation and orthogonal thereto, which may be of interest for certain applications.

A non-woven or fleece consists of fibers loosely laid next to each other without being connected. The rigidity of a fleece solely rests on the fiber-inherent attraction, but may be influenced through further processing. In order to be able to use and process a non-woven (fleece) same is usually solidified, for which solidification several methods may be used.

Fleeces differ from textiles (fabrics) or knitted fabrics, which are characterized by a particular and defined layering of the single fibers or filaments. Fleeces, in contrast, consist of fibers the orientation of which can only be described with statistical methods. The fibers are randomly oriented in the fleece. The English term non-woven thus clearly differentiates fleeces from textiles. Fleeces are differentiated according to the fiber material (e.g. the polymer in case of chemical fibers), the bonding process, the fiber type (staple or endless fibers), the denier of the fibers and the fiber orientation. The fibers may be oriented in a preferred direction or may be entirely stochastically oriented as e.g. in the randomly oriented fleece.

If the fibers do not have a preferred direction for their orientation, the term isotropic fleece is used. If the fibers are oriented in one direction more often than in another direction, the term anisotropy is used.

In the context of the present invention, felts should also be understood as fiber ribbons in the sense of the invention. A felt is a sheet-like product based on unsorted and difficult to separate fiber material. In principle, felts are thus textiles which are not woven: Felts are usually obtained from chemical fibers or natural plant-based fibers through dry needling (so called needled felts) or through solidification with water beams which exit from a beam with dies (die beam) under high pressure. The individual fibers in a felt are interlooped with each other in a random manner.

Needled felts are usually manufactured mechanically with a multiplicity of needles with flukes (barbs), wherein the barbs or flukes are positioned in reverse direction compared to a harpoon. Thereby, the fibers are pressed into the felt and the needle can be easily pulled out. Through repeated stitching the fibers are looped (entangled) with each other and thereafter optionally treated chemically or with water vapor.

Felts—as fleeces—may be manufactured from basically all natural or synthetic fibers. Besides needling or in addition to needling the fibers it is also possible to hook the fibers with a pulsed water beam or a binding agent. The latter methods are in particular suitable for fibers without scale structure such as polyester or polyamide fibers.

Felts show a good temperature stability and are usually moisture-repellent, which may be an advantage in particular for the application in fluid-carrying systems.

Preferably glass fiber textiles or glass fiber rovings are used for the lining hoses in accordance with the present invention.

In accordance with a preferred embodiment the lining hoses in accordance with the present invention comprise, in radial direction, at least two different resin impregnated fiber ribbons positioned on top of each other and obtained by winding.

In accordance with a preferred embodiment the at least two different fiber ribbons differ from each other at least in one of the parameters fiber incorporation, fiber orientation, fiber length or fiber type.

The term fiber incorporation, as used in the context of the present invention, denotes the way in which the fibers are integrated in a carrier material.

The fiber ribbons used are selected in such a manner that the lining hose on one hand has an optimized property profile for the specific application case and on the other hand can be manufactured as simply as possible on available manufacturing devices for the manufacture of respective lining hoses.

Through the combined use of several different fiber ribbons with different constitution (composition) with regard to fiber type, fiber length, fiber bonding or fiber orientation the property profile of the lining hoses in accordance with the present invention can be individually adapted to the specific application case without extensive modifications in the devices used for the manufacture becoming necessary. Through the choice or the sequence in which the at least two different fiber ribbons are arranged it is possible to adapt the radial and longitudinal profile of the lining hoses in accordance with the present invention optimally to the specific application case.

The length of the fibers used is not subject to a particular limitation, i.e. so-called long fibers as well as short fibers or fiber fragments may be used. The length of the fibers may be used to adjust and control the properties of the respective fiber belts (ribbons) over a wide range.

The type of fibers used is not subject to particular limitations either. Only by way of example glass fibers, carbon fibers or polymer fibers such as aramide fibers or fibers based on thermoplastic polymers such as polyesters or polyamides or polyolefins (e.g. polypropylene) are mentioned here, which are known to the person skilled in the art with their properties and which are commercially available in great variety. For economic reasons, glass fibers are usually preferred; if however, a particularly good heat resistance is of importance, however, aramide fibers or carbon fibers may be used, which may offer advantages compared to fibers based on thermoplastic polymers as far as rigidity or stiffness at higher temperatures are concerned.

In some cases it has been found to be advantageous if a first resin impregnated fiber ribbon is selected from fabrics, knitted fabrics, rovings, mats, felts or fleeces whereby the length of the fibers may be selected in accordance with the desired application. The first resin impregnated fiber ribbon may be a fiber roving of parallel oriented endless fibers, preferably parallel oriented endless glass fibers. Preferably the endless fibers are oriented substantially orthogonal to the longitudinal direction of the resin impregnated fiber ribbon. A second fiber ribbon may be preferably combined with such first fiber ribbon, wherein in the second fiber ribbon the fibers are stochastically (randomly) oriented in a fiber mat. The first fiber ribbon provides a good rigidity in the longitudinal direction, which is advantageous during the introduction into the pipe systems to be renovated. The second fiber ribbon with stochastically (randomly) oriented fibers stabilizes the inner surface through its high resin uptake and thereby avoids pores on the inner surface which may lead to damages upon extended contact with aggressive media. Through the use of an oriented fiber roving on the other side the risk that the fiber mat upon impregnation may be drawn apart and thereby an inhomogeneous impregnation may occur, is reduced. Static requirements for the lining hose also render advantageous such an embodiment.

Particularly preferably in a first resin impregnated fiber ribbon the fiber roving may be needled or sewed with a random fiber mat, i.e. the first and also the subsequently introduced fiber ribbons may have a multi-layer structure. In some cases it has found to be advantageous in such embodiment if at least one fiber ribbon positioned on top of a first fiber ribbon has a multi layer structure such that between two layers with randomly oriented fibers an intermediate layer with cut fibers oriented parallel to the longitudinal direction of the fiber ribbon is contained, wherein the cut fibers preferably have a length in the range of from 2 to 60, preferably of from 3 to 30 cm.

In accordance with a particularly preferred embodiment the lining hoses in accordance with the invention comprise a resin impregnated fiber hose which contains at least one fiber ribbon with fibers substantially oriented perpendicular to the longitudinal direction of the fiber ribbon and at least one further fiber ribbon with fibers oriented parallel to the longitudinal direction of the fiber ribbon.

In accordance with a third preferred embodiment a fleece, preferably a fleece of polyolefin fibers, particularly preferred a fleece of propylene fibers is used as first resin impregnated fiber ribbon, which may be combined with any further fiber ribbon of the type described above.

In accordance with a fourth preferred embodiment, a felt as described above is used as one of the fiber ribbons, which felt may again be combined with at least one additional fiber ribbon as described hereinbefore.

As mentioned, it is principally possible to combine arbitrary types of fiber ribbons, which achieve the property profile desired for the planned application as best as possible. Thus, fiber resins with homogenous fiber incorporation (e.g. two fiber rovings or two fiber textiles) may be used, which may contain fibers of different chemical composition, different orientation or with different length. Short fibers in one fiber ribbon may be combined with at least one further fiber ribbon wound thereon or textiles may be combined with fleeces, mats or knitted fabrics. The use of two fiber textiles with fibers of identical incorporation, orientation and length but different chemical composition is also possible. This opens a great scope of variation for the skilled person within which he may tailor the properties of the lining hose for the individual specific application.

Starting from the desired property profile the skilled person will select the suitable fiber ribbons for the lining hoses in accordance with the present invention using his professional knowledge about the properties of the different types of fiber ribbons and is thus able to provide products optimally adapted to the individual case of application.

The width of the fiber ribbons is not subject to particular limitations; for a variety of applications fiber ribbons with a width of from 20 to 150, preferably of from 30 to 100, particularly of from 40 to 80 cm have been found suitable.

The thickness of the fiber resins in the lining hoses according to the present invention is not subject to particular limitations either and is determined by the thickness of the lining hose for the desired application. Thicknesses of the fiber ribbons in the range of from 0.01 to 1, preferably of from 0.05 to 0.5 mm have been successfully used in practice.

In accordance with a preferred embodiment the lining hoses in accordance with the present invention comprise an optionally reinforced inner tubular foil hose which may be removed after installation of the lining hose or which may remain in the conduit system to be renovated. This inner tubular foil, if same is not removed after installation, comprises 0.1 to 40 wt %, based on the total weight of the inner tubular foil hose, of nanoparticles as described hereinbefore. It is also possible that the inner tubular foil hose as well as the resin used for impregnation contains nanoparticles.

As thermoplastic polymer for the inner tubular foil hose principally all polymers are suitable which may be processed to foils respectively foil hoses in the thickness needed for the specific application case. If the curing is effected photochemically it has to be taken into account additionally that the products should have a sufficient transparency for the radiation used for curing. If the inner tubular foil hose remains should remain in the system to be renovated after installation, a sufficient stability towards the transported fluids as well as towards the resin used for impregnation has to be taken into account. In the majority of cases, however, the inner tubular foil hose is removed after curing. Taking into account these criteria, polyolefins such as e.g. polyethylene or polypropylene, polyamides, polyesters such as polybutylene terephthalate, polyethylene terephthalate or polyethylene naphthalate, polyvinyl chloride, polyacrylonitrile or thermoplastic polyurethanes or any mixtures of these polymers are principally suitable. Furthermore, thermoplastic elastomers are principally suitable. Thermoplastic elastomers are materials in which elastic polymer chains are incorporated into thermoplastic materials. Despite the lack of vulcanization, which is necessary in classical elastomers, thermoplastic elastomers have rubber-like elastic properties, which may be advantageous in certain applications. By way of example, polyolefin elastomers or polyamide elastomers may be mentioned. Respective products have been described in the literature and are commercially available from various producers, so that no further details need to be given here.

Particularly preferred and suitable thermoplastic polymers are polyolefins and/or polyamides, of which, in certain application scenarii foil hoses based on composite foils of polyolefins and polyamides have proved to be advantageous, since same have, compared to pure polyethylene foils, a better barrier effect towards styrene, which is often used as solvent for the resins used. Thereby, the release of this solvent/monomer on the inner side of the lining hose prior to curing can be better prevented.

In accordance with a preferred embodiment, the inner foil hose comprises a reinforcement. Same is selected in a manner such that on one hand an optimized property profile for the specific application case is obtained and on the other hand a manufacture of the lining hoses as simply as possible is given.

Particularly preferred the inner foil hose comprises a reinforcement on fiber basis, in particular based on fiber ribbons as described above or on fleeces.

The thickness of the reinforcement, e.g. of the fleeces, is preferably in the range of from 0.001 to 10 mm, particularly preferred in the range of from 0.02 to 5 mm.

In accordance with a particularly preferred embodiment, the reinforcement is a glass fiber fabric or a glass fiber roving.

In accordance with a further preferred embodiment, the inner tubular foil hose comprises a fleece lamination.

In the course of lamination the reinforcement is physically connected with the foil forming the basis of the inner tubular foil hose. One example hereof is the top-lamination of the reinforcement onto the foil, which leads to a partial melting of the foil. Respective processes for lamination are known to the skilled person and have been described in the literature so that no further details need to be given here.

Generally, without however being limited thereto, the flat foil from which the inner tubular foil hose is obtained in accordance with the preferred embodiment, has a thickness in the range of from 40 to 800 μm, preferably of from 50-500 μm and particularly preferably in the range of from 80 to 200 μm.

If the curing after installation in the pipe system to be renovated is effected through exposure to light, care has to be taken that the materials used (for the flat foil, from which the inner tubular foil hose is formed as well as for the foil ribbon) are sufficiently transparent for the light used for irradiation to avoid a negative impact or prevention of the curing. In the case of thermal curing this is not of importance.

In accordance with a further preferred embodiment, the lining hoses in accordance with the invention comprise at least one outer tubular foil hose based on thermoplastic polymers.

Suitable outer tubular foil hoses for use in the lining hoses in accordance with the invention are known and have been described in the literature. By way of example reference is made to WO 95/04646 and WO 00/73692, of which the reinforced outer tubular foil hoses in accordance with WO 00/73692 are preferred.

Principally the at least one outer tubular foil hose should provide protection against light (to avoid a premature and undesired curing in case of photochemical curing) and in addition should prevent the leakage of resin out of the resin-impregnated fiber hoses into the pipe system to be renovated. In particular in the case of pipe systems laid in the soil this is already desirable or necessary under the aspect of protection of the environment. It is also advantageous if the outer tubular foil hose provides a certain degree of protection against mechanical damage upon pulling-in the lining hose into the pipe system to be renovated, where the roughness of the surface or points of breakage incur the risk of mechanical damage of the lining hose.

As suitable materials for the at least one outer tubular foil hose b) principally all thermoplastic polymers are suitable, if applicable, taking into account the individual requirements mentioned above for the individual case. The skilled person will select the suitable thermoplastic polymer in accordance with the pre-set demand profile. The same applies to the thickness and the optional use of reinforcement materials for the outer tubular foil hose upon which the skilled person will decide based on the individual application case.

The lining hose in accordance with the invention is preferably obtained by winding of fiber ribbons onto respectively around the inner tubular foil hose by virtue of a winding mandrel or another suitable device.

Principally it is also possible, however, to obtain tubular fiber hoses by laying closely alongside the longitudinal rims of flat foils and subsequently connecting the rims in a suitable manner. Respective processes are known to the skilled person and have been described in the literature.

In accordance with a preferred embodiment, the lining hose is obtained through winding of fiber ribbons using a device as described in WO 95/04646.

The fiber ribbons in the lining hoses according to the present invention wound on top of each other in this embodiment overlap at their rims, e.g. by 5 to 300 mm.

The final lining hose which usually has a length of from 1 to 1000 m, in particular of from 30 to 300 m, in the course of the pipe renovation is introduced into the pipe system to be renovated and, after introduction, expanded either with pressurized water or preferably with air so that it tightly fits to the inner wall of the pipe system to be renovated. Thereafter the resin is cured thermally with hot water or preferably with UV radiation as described e.g. in EP A 122 246 and EP-A 1 98 17 413.

The lining hoses in accordance with the invention are suitable for the renovation of fluid-carrying pipe systems of any type and allow a rapid renovation while minimizing the off-use time of the system for which same have to be taken out of use. Compared to the replacement of damaged parts off-use times are reduced. The lining hoses in accordance with the present invention may be particularly preferably used for the renovation of systems which are only suited with difficulties for a classical repair or renovation including the replacement of parts because e.g. same are part of an overall device or because they are not accessible e.g. because same are buried in the soil. Examples hereof are pipe systems for the transport of water or wastewater which are laid in cities and communities in the soil and often below streets or other traffic lines. In the case of renovation through replacement these pipe systems have to made accessible by digging first and the traffic lines are not available for traffic for extended periods of time which in particular in case of higher traffic volumes leads to significant disadvantages. Compared thereto, the renovation of such pipe systems with the lining hoses in accordance with the present invention may be carried out without digging in a few hours or days without extended ground work being necessary.

The nanoparticles in the reactive resins used for impregnation lead to an improvement of the surface structure of the surface of the lining hose which is, if applicable, after removal of the inner tubular foil hose optionally present, in contact with the flowing medium, whereby the friction and thus the abrasive effect of the fluid medium may be reduced. If the inner tubular foil hose is not removed, the nanoparticles present therein improve the abrasion caused by the flowing medium. In this case it is not necessary that the resin which is used for the impregnation of the tubular fiber hose, also contains nanoparticles. The desired reduction of abrasion is already achieved through equipping the inner tubular foil hose with nanoparticles.

Furthermore, the addition of nanoparticles to the resin used for impregnation leads to an improvement of the mechanical properties such as e.g. elastic modulus or rigidity (stiffness).

The use of nanoparticles in the resin used for impregnation further has the advantage that the resins so obtained have a very good transparency for the radiation used for curing because the particle size of the nanoparticles is smaller than the wavelength of the radiation. This facilitates the complete and homogenous curing of the lining hoses in accordance with the invention compared to resins comprising larger particles.

1. Lining hose for the renovation of fluid-carrying systems, comprising at least one resin impregnated fiber hose, and optionally comprising a reinforced or unreinforced inner tubular foil hose on the surface of the resin impregnated fiber hose oriented towards the flowing medium, wherein 0.1 to 40 wt % of nanoparticles, based on the weight of the resin respectively based on the weight of the inner tubular hose, are added to the resin used for impregnation or to the inner tubular foil hose.

2. The lining hose of claim 1 wherein 0.1 to 40 wt %, based on the entire weight of the resin, of nanoparticles are added to the resin used for impregnation.

3. The lining hose according to claim 1 wherein 0.1 to 40 wt %, based on the entire weight of the inner tubular hose, of nanoparticles are added to the inner tubular hose.

4. The lining hose of claim 1 characterized in that the nanoparticles at the time of incorporation into the resin used for impregnation has an average particle size D₅₀ or a biggest dimension in one spatial direction of 300 nm.

5. The lining hose in accordance with claim 1 characterized in that an unsaturated polyester resin or a vinyl ester resin is contained as resin.

6. The lining hose in accordance with claim 1 characterized in that the fiber ribbon is a fabric, knitted fabric, roving, mat or non-woven (fleece)

7. The lining hose in accordance with claim 1 characterized in that the fiber ribbon is a glass fiber textile or glass fiber roving.

8. The lining hose in accordance with claim 1 characterized in that the nanoparticles are metal oxides, metal carbonates, metal sulfates, wollastonite, xonotlite, sepiolite, attapulgite, palygorskite or carbon nanotubes.

9. The lining hose in accordance with claim 1 characterized in that the inner tubular foil hose comprises a reinforcement.

10. The lining hose in accordance with claim 1 characterized in that it comprises an outer tubular foil hose.

11. (canceled)

12. A method for renovation of water and wastewater pipe systems with use of the lining hose of claim 1.
